(19) United States
(12) Patent Application Publication
(10) Pub. No.: US 2019/0156330 A1
(43) Pub. Date: May 23, 2019

(54) METHOD AND SYSTEM FOR TRANSIT PROCESSING

(71) Applicant: Visa International Service Association, San Francisco, CA (US)

(72) Inventors: Meredith Altenhofen, San Francisco, CA (US); John F. Sheets, San Francisco, CA (US)

(21) Appl. No.: 16/098,988

(22) PCT Filed: Jun. 29, 2017
(86) PCT No.: PCT/US2017/040062

§ 371 Date: Nov. 5, 2018

Related U.S. Application Data
(60) Provisional application No. 62/356,414, filed on Jun. 29, 2016.

(51) Int. Cl. G06Q 20/34; G06Q 20/38; G06Q 20/40; G07C 9/00

(52) U.S. Cl. CPC G06Q 20/352; G06Q 20/38215; G07C 9/00103; G06Q 20/341; G06Q 20/409

(57) ABSTRACT

A method is disclosed. The method includes receiving, by an access device and from a communication device operated by a user, credential data. The method additionally includes simultaneously transmitting, by the access device, the received credential data in an authorization request message to a server computer and initiating, by the access device, an offline data authentication (ODA) process using the received credential data. The method further includes, in response to receiving, by the access device and from the server computer, an authorization response message within a predetermined period of time after transmitting the credential data in the authorization request message to the server computer, determining whether to grant or deny the user access to a resource based on the received authorization response message, otherwise determining whether to grant or deny the user access to the resource based on a result of the ODA process.

### CROSS-REFERENCE TO RELATED APPLICATIONS

This application is a non-provisional application of and claims the benefit of the filing date of U.S. Provisional Application No. 62/356,414, filed on Jun. 29, 2016, which is herein incorporated by reference in its entirety for all purposes.

### BACKGROUND

Transit fare collection has been moving toward a model to utilize contactless payment cards at fare gates. The contactless payment cards may be physical payment cards or payment data stored on mobile communication devices. The contactless payment cards may be issued to the user by an authorizing entity. Users may scan or tap the contactless payment cards at the fare gates in order to be granted entry to the transit terminal (or other building). A standard payment system channel may include a merchant system, an acquirer, an acquirer processor, a payment processing system (e.g., VisaNet), an authorizing entity, an authorizing entity processor, etc.

Some transit agencies have targeted a 300 milliseconds (ms) transaction time to meet the needs of a transit environment in order to process 30 to 45 patrons per minute through a fare gate access device. Because of these transaction speed considerations, transit fare agencies have positioned their solution as an off-line transaction, rather than an on-line transaction, at the fare gate or farebox. However, performing an on-line transaction can provide additional benefits over an off-line transaction.

Embodiments of the invention address the above problems, and other problems, individually and collectively.

### SUMMARY

Some embodiments of the invention are directed to a method. The method may include receiving, by an access device and from a communication device operated by a user, credential data. The method may also include simultaneously transmitting, by the access device, the received credential data in an authorization request message to a server computer and initiating, by the access device, an offline data authentication (ODA) process using the received credential data. The method may further include, in response to receiving, by the access device and from the server computer, an authorization response message within a predetermined period of time after transmitting the credential data in the authorization request message to the server computer, determining whether to grant or deny the user access to a resource based on the received authorization response message, otherwise determining whether to grant or deny the user access to the resource based on a result of the ODA process.

In some embodiments, the predetermined period of time is 500 milliseconds (ms).

In some embodiments, the resource is at least one of a transit system, event venue, or building.

In some embodiments, the communication device comprises at least one of a mobile device or a payment card.

In some embodiments, the credential data comprises a primary account number associated with the communication device, and the primary account number is used to initiate transactions at other access devices.

In some embodiments, the method may additionally include updating a blacklist based on at least one of the received authorization response message or the result of the ODA process.

In some embodiments, the method may additionally include, in response to receiving, by the access device and from the server computer, the authorization response message following the predetermined period of time after transmitting the credential data in the authorization request message to the server computer, updating a blacklist based on the received authorization response message.

In some embodiments, the credential data comprises a cryptogram, and the result of the ODA process is indicative of whether the cryptogram is valid.

In some embodiments, the server computer is a part of a payment processing network.

In some embodiments, the credential data is received via a contactless communication protocol.

Other embodiments of the invention are directed to devices, servers and systems that are configured to perform the above-described method.

### BRIEF DESCRIPTION OF THE DRAWINGS

FIG. 1 shows a schematic diagram of a transit-payment system according to an embodiment of the invention.

FIG. 2 shows a block diagram illustrating components in one type of an access device, according to some embodiments.

FIG. 3 illustrates components of a portable consumer device in the form of a phone, according to some embodiments.

FIG. 4 illustrates components of a portable consumer device in the form of a card, according to some embodiments.

FIGS. 5A-5B shows a flowchart illustrating methods according to embodiments of the invention.

FIGS. 6A-6B shows a flowchart illustrating additional methods according to some embodiments of the invention.

### DETAILED DESCRIPTION

Embodiments of the invention are directed to methods and systems that allow for access to a transit system using simultaneous on-line and off-line authorization processes initiated at the transit terminal or fare gate. An online process can contact an authorizing entity via a network to receive an approval or non-approval indicator (e.g., approve or decline) for a fare for access to the transit system. An off-line process (e.g., ODA) at the transit terminal may be accomplished without full authorization by the authorizing entity. If a response indicating approval or non-approval is received from the authorizing entity within a predetermined period of time, results of the on-line authorization process may be used to grant or deny access to a patron at the transit terminal or fare gate. If the response from the authorizing entity is not received within the predetermined period of time, the results of the off-line authorization may be used to grant or deny access to the patron at the transit terminal or fare gate. If the patron is denied access to the transit terminal, a negative file associated with the patron may be updated. Embodiments of the invention may also be used for authorizing a patron for access to other venues besides transit terminals, such as sports venues, other buildings, etc. Embodiments of the invention can allow access to a system (e.g., transit system, sports venue, etc.) within 1 second, 500 milliseconds, 300 milliseconds, or less.

Performing both an online authorization and an off-line authorization simultaneously can provide the advantage for better risk management. Additionally, by performing both authorizations in parallel, in contrast to performing them in series, allows for increased throughput at the access device (e.g., more patrons or users may be able to get through the transit gates faster).

Prior to discussing embodiments of the invention, descriptions of some terms may be helpful in understanding embodiments of the invention.

A “communication device” may comprise any electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of communication devices include mobile phones (e.g., cellular phones), PDAs, tablet computers, net books, laptop computers, personal music players, hand-held specialized readers, wearable devices (e.g., watches), vehicles (e.g., cars), etc. A communication device may comprise any suitable hardware and software for performing such functions, and may also include multiple devices or components (e.g., when a device has remote access to a network by tethering to another device—i.e., using the other device as a relay—both devices taken together may be considered a single communication device). A communication device may also include a payment card storing account credential data.

“Authentication data” or “credential data” may include any data suitable for authenticating a user or communication device. Authentication data may be obtained from a user or a communication device that is operated by the user. Examples of authentication data obtained from a user may include PINs (personal identification numbers), passwords, etc. Examples of authentication data that may be obtained from a communication device may be include device serial numbers, hardware secure element identifiers, device fingerprints, phone numbers, IMEI numbers, etc.

A “server computer” be any suitable computational device that can receive and respond to requests from a client device. A server computer may be a powerful computer or cluster of computers. For example, a server computer can be a large mainframe, a minicomputer cluster, or a group of servers functioning as a unit. In one example, the server computer may be a database server coupled to a Web server.

“Access data” may include any suitable data that can be used to access a resource or create data that can access a resource. In some embodiments, access data may be account information for a payment account. Account information may include a PAN, payment token, verification values (e.g., CVV, CVV2, dCVV, dCVV2). In other embodiments, access data may be data that can be used to activate account data. For example, in some cases, account information may be stored on a communication device, but may not be activated until specific information is received by the communication device. This specific information may be characterized as access information in some embodiments. In other embodiments, access data could include data that can be used to access a location. Such information may be ticket information for an event, data to access a building, transit ticket information, etc.

An “application” may be a computer program that is used for a specific purpose.

An “access device” may be any suitable device for obtaining access to a resource. An access device may generally be located in any suitable location, such as at the location of a merchant. An access device may be in any suitable form. Some examples of access devices include transit gates, turnstile entry gates, POS devices, cellular phones, PDAs, personal computers (PCs), tablet PCs, teller machines (ATMs), kiosks, security systems, and access systems.

An “authorizing entity” may be an entity that authorizes or does not authorize requests. An authorizing entity may be a business entity (e.g., a bank) that maintains and/or issues an account for a user that is associated with a portable communication device, such as an account enrolled in a mobile application installed on a portable communication device. An example of an authorizing entity may be an issuer.

An “authorization request message” may be an electronic message that requests authorization for a particular action. In some embodiments, an authorization request message is sent to a payment processing network and/or an authorizing entity of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an authorizing entity account identifier that may be associated with a payment device or payment account. An authorization request message may also comprise additional data elements corresponding to “identification information” including, by way of example only: a service code, a CW (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, an authorization request message is generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization.

A “processor” may refer to any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a computer readable medium that stores instructions that can be executed by a processor to implement a desired method. Examples of memories may comprise one or more memory chips, disk drives, etc. Such memories may operate using any suitable electrical, optical, and/or magnetic mode of operation.

Systems and Devices

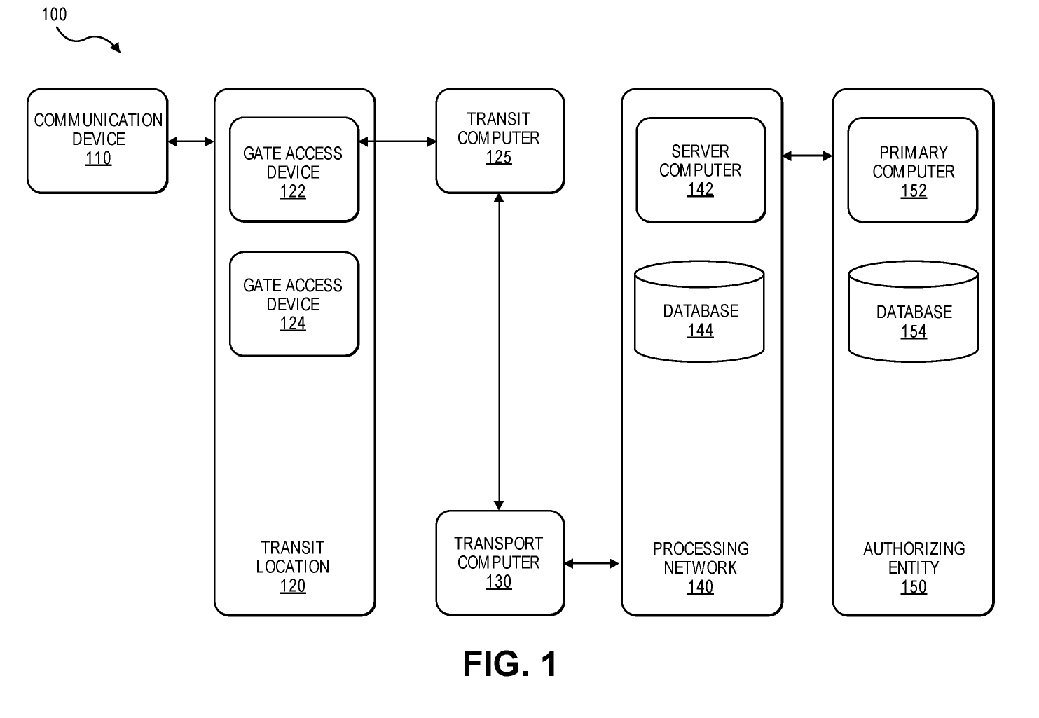

FIG. 1 shows a schematic diagram of a system 100, according to some embodiments. FIG. 1 shows a communication device 110, a transit location 120 comprising a plurality of gate access devices including a first gate access device 122 and a second gate access device 124, a transit computer 125 a transport computer 130, a processing network 140 including a server computer 142 and a database 144, and an authorizing entity 150 including a primary computer 152 and an associated database 154. The above-described components can be in operative communication with each other, and/or may be operatively coupled to each other in any suitable manner.

The various components in FIG. 1 may communicate with each other using any suitable communications network 120, including without restriction, the Internet, a wide area network (WAN), a local area network (LAN), an Ethernet network, a public or private network, a wired network, a wireless network, and the like, and combinations thereof. Different communication protocols may be used to facilitate the communications including both wired and wireless protocols such as IEEE 802.XX suite of protocols, TCP/IP, IPX, SAN, AppleTalk, Bluetooth, and other protocols.

The user (e.g., rider or patron) of the communication device 110 may also be a consumer of goods and/or services, and/or may be a patron of various transit systems.

Embodiments of the invention may include any suitable communication device 110. For example, communication device 110 can be hand-held and compact so that it can fit into a consumer's wallet and/or pocket (e.g., pocket-sized). Examples of communication device 110 may include cellular phones, personal digital assistants (PDAs), pagers, payment cards, payroll cards, security cards, access cards, smart media, transponders, and the like. Communication device 110 may interface with gate access device 122 or other suitable type of access device using any suitable mechanism including any suitable electrical, magnetic, or optical interfacing system.

The communication device 110 may include a volatile or non-volatile memory to store information such as the cardholder's primary account (PAN) number, name, and other information. In some embodiments, the communication device 110 may have multiple functions. For example, the communication device 110 can be used in a retail environment in some embodiments, and could also be additionally or alternatively used in a transit environment.

In some embodiments, the communication device 110 may be issued by an authorizing entity 150. The authorizing entity 150 may provide an account number associated with the transit user that may be used to initiate payment transactions at access devices other than the gate access device 122 (e.g., with merchants that provide goods and services, without providing access to a transit system or sports venue, etc.). This may be beneficial over other communication devices 110 or payment cards that are issued by the transit system or sports venue, which may be incapable of being used with other merchants that do not provide access to a transit system or sports venue.

As shown in FIG. 1, the system 100 may include an transport computer 130 and an authorizing entity 150. The transport computer 130 may be part of a bank network that is associated with the transit agency associated with the transit location 120.

The transit location 120 can be any suitable location that is associated with transit. For example, the transit location can be a bus stop, a subway station, a train station, an airport, etc. In addition, although “transit” is discussed in detail herein, embodiments of the invention can be used in any suitable situation where access to a particular location is desired, but is conditional upon authorization (e.g., building access or venue access).

The processing network 140 and any communication network that communicates with the processing network 140 may use any other suitable wired or wireless network, including the Internet. The processing network 140 may be adapted to process ordinary debit or credit card transactions. In some embodiments, the processing network 140 may comprise or use a payment processing network such as VisaNet™.

The authorizing entity 150 may also have a primary computer 152 and a database 154 associated with the primary computer 152. If the above described first gate access device 122 comprises a first processor and a first computer readable medium associated with the first processor, then the primary computer 152 may comprise a second processor and a second computer readable medium. The second computer readable medium comprises code or instructions for receiving the authorization request message, generating the authorization response message, and then sending the authorization response message to the first gate access device 122.

The gate access device 122 may comprise a third processor and a third computer readable medium. The computer readable medium may comprise instructions or code for determining a transit fare after the user enters the location, and then sending data relating to the transit fare to the transit computer 125, which may be associated with the transit agency.

For simplicity of illustration, a specific number of components is shown in FIG. 1. However, it is understood that in other embodiments of the invention, there can be many more components or fewer components.

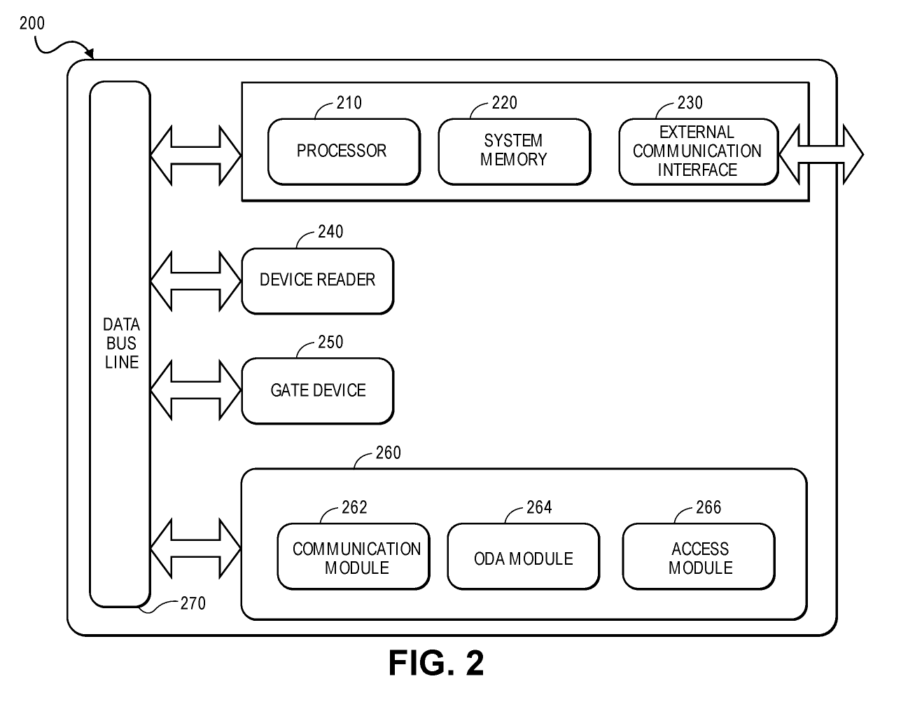

FIG. 2 shows a block diagram illustrating components in one type of an access device 200, according to some embodiments. In some embodiments, the access device 200 may be a gate access device, similar to the gate access devices 122, 124. In some embodiments, the access device 200 may reside within the transit location 120. For example, a patron at an transit location may scan or tap his/her communication device 110 at the access device 200 in order to gain access to the transit location.

The access device 200 may include a processor 210, which may be coupled to a system memory 220 and an external communication interface 230. The access device 200 may also include a device reader 240 (for reading a communication device 110 upon a scan or tap performed by the user), a gate device 250 (such as a turnstile, a barrier, a gate etc.), and a computer readable medium 260, which all may be operatively coupled to the processor 210 via a data bus line 270. A housing may house one or more of these components. Examples of access device 200 can include RF (radio frequency) antennas, magnetic stripe readers, etc. that interact with the communication device 110.

The computer readable medium 260 may store code or instructions for allowing access device 200 to operate in the manner described herein. The instructions may be executed by the processor 210. The computer readable medium 260 may comprise code or instructions for receiving a request for access to a location at an access device 200 from a patron/user, and generating an authorization request message, where the authorization request message includes a request to charge a pre-determined amount of money to pay for access to the transit location 120, sending the authorization request message to an authorizing entity 150 for approval, and receiving an authorization response message, wherein the authorization response message indicates whether or not the charge is authorized or not authorized, and if the authorization response message indicates that the charge is authorized, then allowing the patron/user to access the transit location 120.

The computer readable medium 260 may comprise a number of software modules including a communication module 262, ODA module 264, and an access module 266.

The communication module 342 may comprise code that causes the processor 310 to generate messages, forward messages, reformat messages, and/or otherwise communicate with other entities.

The communication module 346 may comprise code, which causes the processor 210 to communicate with other devices via the external communication interface 230. For example, the communication module 346 may establish various communication protocols for the access device 200 to send and receive messages to and from the communication device 110, transport computer 130, processing network 140, and/or authorizing entity 150. In an example, the communication module 346 may facilitate communication between the access device 200 and the communication device 110 upon a scan or tap performed by a patron/user using the communication device 110 with the access device 200. In another example, the communication module 262 may generate an authorization request message to be transmitted from the access device 200 to the processing network 130. In yet another example, the communication module 262 may receive an authorization response message from the processing network 130.

The ODA module 264 may comprise code, which causes the processor 210 to perform an ODA process to authenticate a patron/user's communication device 110 prior to the access device 200 granting or denying the patron/user entry to the transit location 120. ODA is a method that allows the access device 200 to determine the authenticity of the communication device 110 and the authorizing entity of the communication device 110 using cryptographic methods. In some embodiments, the communication device 110 may generate a cryptogram (e.g., by encrypting data including an account number on the communication device) and can then transmit it to the access device 200, which may then determine if the cryptogram is present in memory or can be independently created for verification. A typical ODA process may take between 360 ms and 460 ms to complete. An ODA process may allow transit operators and other merchants alike to mitigate transaction risk by authenticating the communication device 110 offline. If transit operators can prove the communication device 110 is genuine and not on their own negative file or hotlist, they can open the gates to the transit location to allow the patron/user to enter.

The access module 266 may comprise code, which causes the processor 210 to either grant or deny access to the patron/user via the gate device 250, based on a result of either the ODA process carried out by the ODA module 264 or an authorization response messaged received from the processing network 140, or both. The access module 266 may also facilitate updating a negative file or hotlist based on the received result(s).

The external communication interface 230 may allow the access device 200 to send and receive messages to and from the communication device 110, transport computer 130, processing network 140, and/or authorizing entity 150.

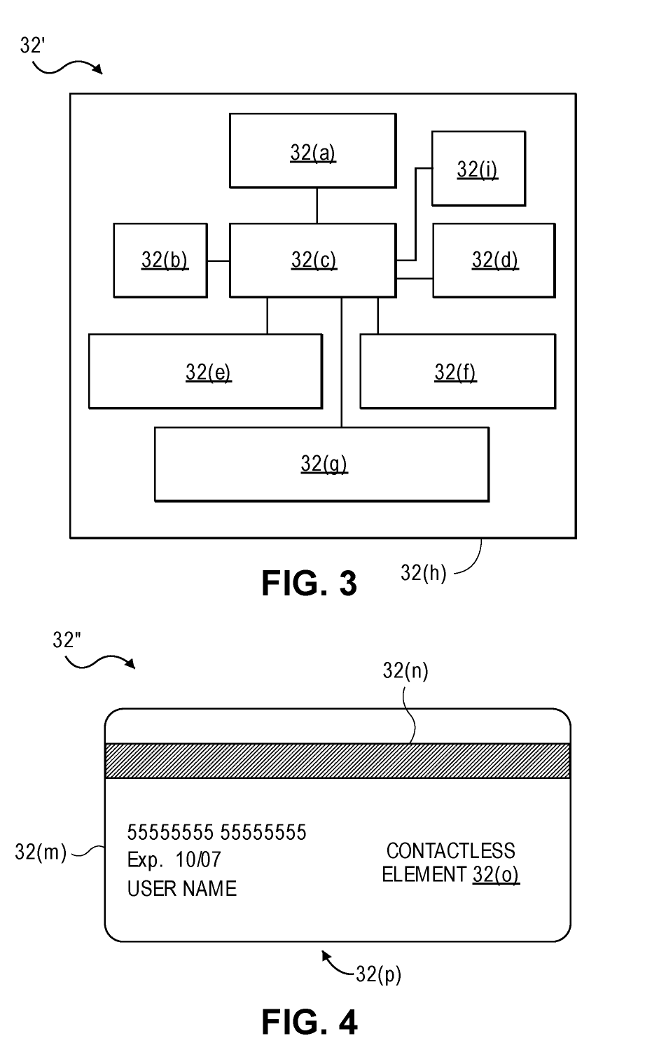

FIG. 3 illustrates components of a portable consumer device 32′ in the form of a phone, according to some embodiments. The components of the portable consumer device 32′ may be used in the communication device 110.

An exemplary portable consumer device 32′ in the form of a phone may comprise a computer readable medium and a body 32(h) as shown in FIG. 3. FIG. 3 shows a number of components, and the portable consumer devices or communication devices according to embodiments of the invention may comprise any suitable combination or subset of such components. A computer readable medium 32(b) may be present within a body 32(h), or may be detachable from it. The body 32(h) may be in the form of a plastic substrate, housing, or other structure. The computer readable medium 32(b) may be a memory that stores data and may be in any suitable form including a magnetic stripe, a memory chip, etc. The memory preferably stores information such as financial information, transit information (e.g., as in a subway or train pass), access information (e.g., as in access badges to a sports venue), etc. Financial information may include information such as bank account information, bank identification number (BIN), credit or debit card number information, account balance information, expiration date, consumer information such as name, date of birth, etc. Any of this information may be transmitted by the portable consumer device 32′.

In some embodiments, and regardless of the type of portable consumer device that is used, information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The portable consumer device 32′ may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) portable consumer device 32′ and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and the optional contactless element 32(g).

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable consumer device 32′ and an interrogation device. Thus, the portable consumer device 32′ is capable of communicating and transferring data and/or control instructions via both cellular network and near field communications capability.

The portable consumer device 32′ may also include a processor 32(c) (e.g., a microprocessor) for processing the functions of the portable consumer device 32′ and a display 32(d) to allow a consumer to see phone numbers and other information and messages. The portable consumer device 32′ may further include input elements 32(e) to allow a consumer to input information into the device, a speaker 32(f) to allow the consumer to hear voice communication, music, etc., and a microphone 32(i) to allow the consumer to transmit his/her voice through the portable consumer device 32′. The portable consumer device 32′ may also include an antenna 32(a) for wireless data transfer (e.g., data transmission).

If the portable consumer device 32′ is in the form of a debit, credit, or smartcard, the portable consumer device may also optionally have features such as magnetic stripes. Such devices can operate in either a contact or contactless mode.

FIG. 4 illustrates components of a portable consumer device 32″ in the form of a card, according to some embodiments. FIG. 4 shows a plastic substrate 32(m). A contactless element 32(o) for interfacing with an access device 200 may be present on or embedded within the plastic substrate 32(m). Consumer information 32(p) such as an account number, expiration date, and consumer name may be printed or embossed on the card. Further, a magnetic stripe 32(n) may also be on the plastic substrate 32(m). The portable consumer device 32″ may also comprise a microprocessor and/or memory chips with user data stored in them.

As shown in FIG. 4, the portable consumer device 32″ may include both a magnetic stripe 32(n) and a contactless element 32(o). In other embodiments, both the magnetic stripe 32(n) and the contactless element 32(o) may be in the portable consumer device 32″. In other embodiments, either the magnetic stripe 32(n) or the contactless element 32(o) may be present in the portable consumer device 32″.

### II. Exemplary Methods

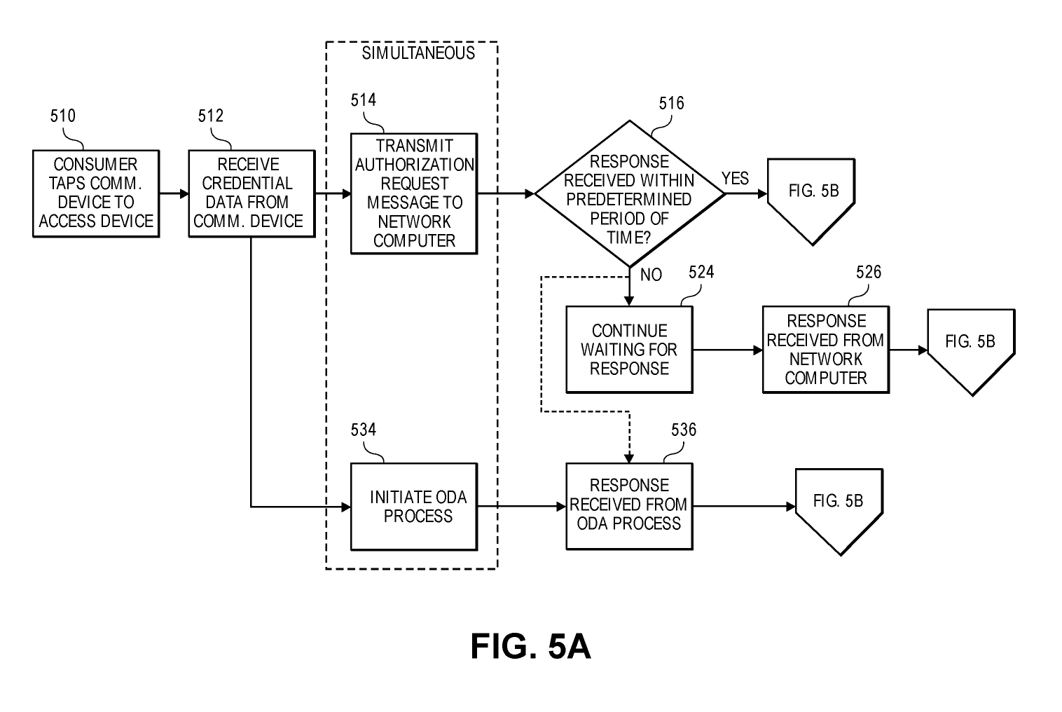

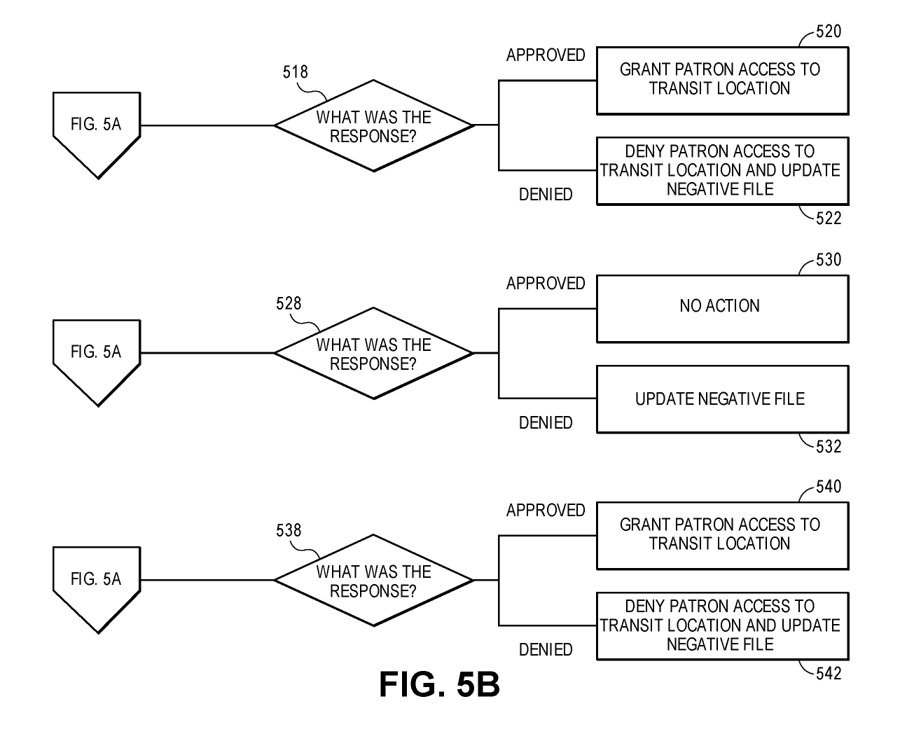

FIGS. 5A-5B (hereinafter “FIG. 5”) shows a flowchart illustrating methods according to embodiments of the invention. It is understood that methods according to embodiments of the invention may include some, all, or any suitable combination of steps shown in FIG. 5. Reference is also made to components in FIGS. 1 and 2.

At step 510, a potential patron or user of a transit system can interact with a gate access device 200 using a communication device 110. Any suitable type of interaction can take place. For example, in one example, the communication device 110 operated by the user may be in the form of a payment card having a contactless element including a chip and an antenna. The first gate access device 122 or second gate access device 124 may have a corresponding contactless reader that can read data stored in the chip via the antenna. The user can, for example, tap, pass (within a proximate distance of the first gate access device 122 or second gate access device 124, etc.), or swipe the communication device 110 on the first gate access device 122 or second gate access device 124.

At steps 512 and 514, after the access device 200 receives the credential data from the communication device 110, the access device 200 may transmit an online authorization request message for a pre-determined fare amount to the transport computer 130 via the transit computer 120. The transport computer 130 may forward the authorization request message to the processing network 140, and the processing network 140 may forward the authorization request message to the authorizing entity 150 for authorization. In some embodiments, the communication module 262 of the access device 200 can transmit the authorization request message. The authorization request message may contain information (or any subset of such information) including the track 1 and track 2 type information (e.g., BIN number, expiration date, etc.), or other credential data, described above.

The authorization request message may include data relating to a request to charge a pre-determined amount of money to pay for access to the transit location 120 (e.g., fixed amount, average amount, amount associated with the patron's or user's past transit history, etc.). For example, in some embodiments, the request to charge may be equal to an average or maximum fare charged by the transit agency for a transit service offered by the transit agency. The authorizing entity 150 can place a “hold” on the patron's or user's account with the authorizing entity for that amount.

Alternatively, the authorization request message may comprise a predicted fare charged by the transit agency for the user based on the patron's user's past use and/or payment history with the transit agency. The access device 200 may obtain data relating to the patron's or user's prior use of the system (e.g., from the server computer 142 of the processing network 140 or the primary computer 152 of the authorizing entity 150 (FIG. 1)). For example, a processor in the server computer 142 of the processing network 140 may determine that 95% of the time, the user travels between transit stations A and B and the cost of the trip from transit station A to transit station B is about $5.00. The transmitted authorization request message may therefore request approval for a charge of $5.00 before the user is allowed to enter a secured area of the transit location 120. In the unlikely event that the user's journey costs more than $5.00, the transit agency may bear the risk that the user will be able to pay for the difference.

As described above, the authorization request message may be transmitted to the authorizing entity 150 via the processing network 140. The primary computer 152 of the authorizing entity 150 can then determine if the transaction is authorized or not. For example, the primary computer 152 can communicate with an associated database 154, which may contain information regarding the status of an account associated with the communication device 110. If the user associated with the account has sufficient credit or funds in the account, then the transaction may be authorized. If there are insufficient funds or credit in the user's account, then the transaction may not be authorized.

Briefly turning to block 534, an offline data authentication (ODA) process may be initiated by the access device 200 substantially simultaneous to performing step 514. The ODA process may comprise, for example, a challenge message transmitted from the access device 200 to the communication device 110. The communication device 110 can calculate a value (e.g., an encrypted value) in response to the challenge message and transmit a challenge response and identifying information to the access device 200. The access device 200 can analyze the challenge response and the identifying information to determine whether the communication device 110 is valid (e.g., authenticated). The access device 200 may use public key cryptography (e.g., RSA key technology), static data authentication (SDA), and/or dynamic data authentication (DDA) to determine the validity of the communication device 110. DDA can include standard DDA or combined DDA/generate application cryptogram (AC), or CDA. SDA can validate that the communication device 110 has not been fraudulently altered since personalization. A digital signature may be created using certain credential data and may be personalized on the communication device 110. When SDA is performed, the access device 200 may use a public key associated with the authorizing entity 150, which may also be stored on the communication device 110, to validate the digital signature. With DDA, the communication device 110 may have a key that creates a dynamic digital signature, valid only for one authentication, using credential data and unique access device 200 data. The access device 200 may use an integrated circuit card (ICC) public key, which is stored on the communication device 110, to validate the digital signature. For CDA, the generation of the digital signature may be combined with the generation of the communication device's 110 application cryptogram to ensure that the application cryptogram came from a valid communication device 110. The communication device 110 may create the dynamic digital signature using communication device-resident data, communication device generated data (AC application cryptogram), and access device 200 data (an unpredictable number).

As described above, steps 514 and 534 may be executed in parallel, which may include transmitting an online authorization request for a pre-determined fare amount with an authorizing entity 150 and initiating an offline data authentication (ODA) process at the same time. This may be beneficial over other systems that may implement one or more of these steps sequentially that can cause a time delay that exceeds a time threshold.

Turning back to step 516, after the access device 200 transmits the authorization request message to the authorizing entity 150 (via the transport computer 130 and the processing network 140), the access device 200 may start a timer associated with the transmitting of the online authorization request (e.g., at the same time that the online authorization request is transmitted, etc.). The access device 200 may determine whether an elapsed time between the first time (e.g., when the timer is started) and a current time has passed a time threshold (e.g., within 1 second, 500 milliseconds, 300 milliseconds, etc.). For example, when the online authorization (at step 514) fails to complete within a time threshold (e.g., an authorization response message has not been received within the time threshold), the method may proceed (at step 536) by receiving only results from the offline data authentication (ODA) process, without receiving an authorization response to the online authorization request for the pre-determined fare amount from the authorizing entity computer. The patron or user may be allowed or not allowed to enter the transit location 120 based upon a presence of an approval or non-approval indicator in an ODA process message, respectively. However, the access device 200 may continue to wait for an authorization response to the online authorization request in step 524 even after granting or denying the patron or user access to the transit location 120 based on the presence of an approval or non-approval indicator in an ODA process message, which is described in further detail below.

At step 538 (FIG. 5B), the system may receive the results from the offline data authentication (ODA) process (e.g., pass or fail) and determine whether to grant or deny the patron or user access to the transit location 120. For example, if the ODA process passes, the patron user may be granted access to the transit location 120 (step 540 (FIG. 5B)). If the ODA process fails, the user may be prevented from accessing the system using this process and a negative file be updated to include the details of the authentication attempt and the associated communication device 110 used (step 524 (FIG. 5B)). In some examples, the user may be allowed to access the system using other authentication or authorization methods (e.g., purchasing a ticket from a kiosk, etc.).

If, however, an online authorization response message is received by the access device 200 and from the authorizing entity 150 within the time threshold (e.g., at step 516), the system may allow or not allow the user to enter the transit location 120 based upon a presence of an approval or non-approval indicator in the received online authorization response message, respectively. For example, at step 518 (FIG. 5B), if the access device 200 receives an authorization response message from the authorizing entity 150 (via the processing network 140 and the transport computer 130), the access device 200 may determine the presence of an approval or non-approval indicator in the received online authorization response message. At step 520 (FIG. 5B), if it is determined that the authorization response message indicates that the patron or user is approved and the communication device 110 is authenticated, the access device 520 may grant the user or patron access to the transit location 120 via one of the gate devices. Otherwise, at step 522 (FIG. 5B), if it is determined that the authorization response message indicates that the patron or user is not approved and/or the communication device 110 is not authenticated, the access device 200 may deny the user or patron access to the transit location 120 and update the negative file as described above.

Referring back to step 524 and as described above, if the online authorization (at step 514) does not complete within the time threshold (e.g., an authorization response message is not received within the time threshold), the access device 200 may continue to process the online authorization (e.g., by waiting for a response to the transmitted online authorization request from the authorizing entity 150 etc.). In some instances, the patron or user may be allowed to access the transit location 120 before the online authorization has completed but after the ODA process completes, as described above. The information received in response to the online authorization may still be beneficial even though the information received in response to the online authorization may not help determine whether the user is allowed to access the transit location 120. For example, information received in response to the online authorization (step 526) may be used to update the negative file even after the patron or user has entered the transit location 120. It may also be possible to deny the patron with the ability to exit the transit system at an end destination if the authorization response indicates that there are insufficient funds in the patron's account.

At step 528 (FIG. 5B), after the access device 200 receives a response to the online authorization after the expiration of the time threshold, additional processing and data transmissions may be performed outside of the time threshold. For example, a response to the online authorization request may be received and the response may be analyzed by the access device 200. If access to the transit location 120 is approved, no action (step 530 (FIG. 5B)) may be taken because the patron or user may have already accessed the transit location 120 since the results of the ODA process were used to grant the user access to the transit location 120 after the expiration of the time threshold. If the transit user is declined, the negative file may be updated (step 532 (FIG. 5B) to identify the patron or user (e.g., lack of funds, high risk user, etc.) for future authorization attempts.

If the authorization response message indicates that the transaction is approved (e.g., using the approval or non-approval indicator, etc.), then the user may be allowed to access the transit location 120. The first gate access device 122 or second gate access device 124 can have a gate device such as gate device 250 (FIG. 2) that can unlock or actuate (e.g., automatically in response to receipt of an authorization response message that indicates that the transaction is authorized) allowing the patron or user to enter the transit location 120.

After the user has accessed the transit location 120 and after the user has completed his journey (e.g., left the transit system through another access device at another transit location of the transit system, etc.), the actual cost of patron or user access may be determined and a clearing and settlement process may be initiated between the transport computer 130 and the authorizing entity 150.

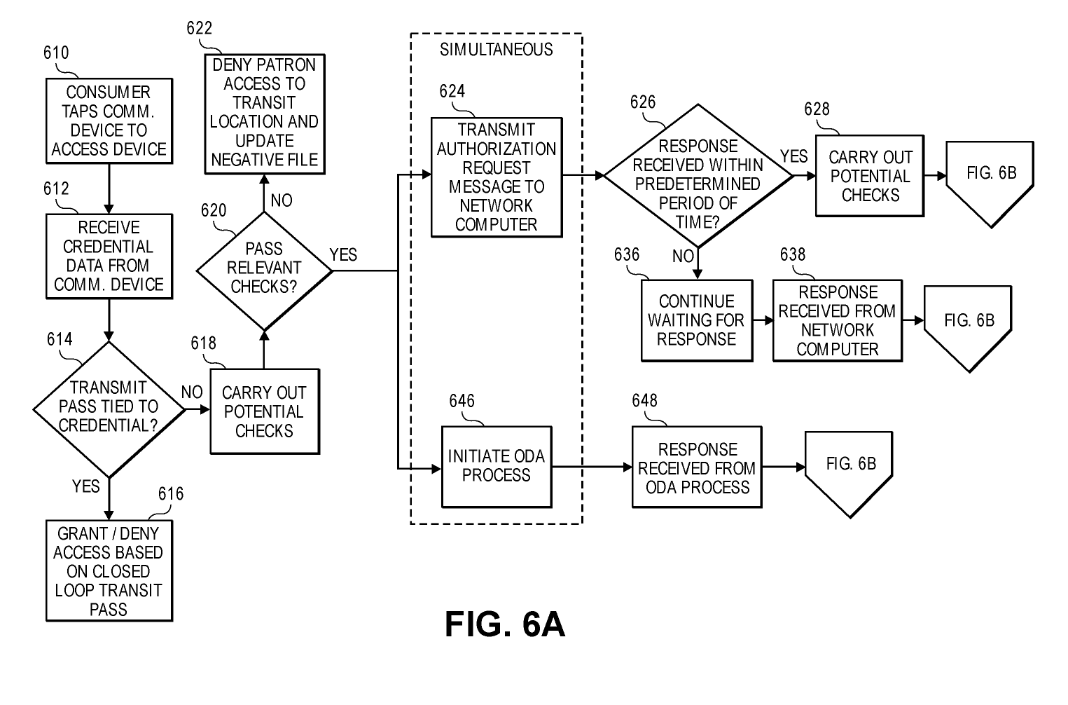

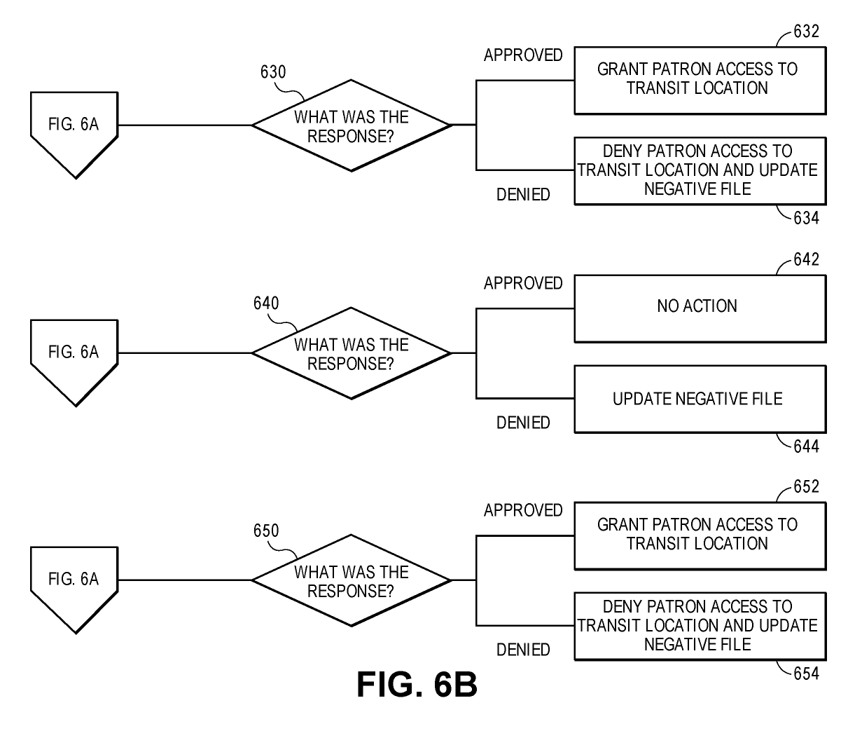

FIGS. 6A-6B (hereinafter “FIG. 6”) shows a flowchart illustrating additional methods according to some embodiments of the invention. It is understood that methods according to embodiments of the invention may include some, all, or any suitable combination of steps shown in FIG. 6. FIG. 6 is in most part similar to FIG. 5, and the steps repeated from FIG. 5 are discussed in detail with respect to FIG. 5.

At step 610, a potential patron or user of a transit system can interact with a gate access device 200 using a communication device 110. At step 612, after the consumer interacts (e.g., taps) with the access device 200 using the communication device 110, a request to access the transit location 120 may be received by the system, via access device 200, after the interaction.

At step 614, the access device 200 may determine whether the communication device 110 is associated with a transit pass (e.g., daily, weekly, monthly or annually funded account, multi-trip ticket, etc.). For example, the access device 200 may determine whether the transit pass exists and/or perform alternative processing based on the determination. If there is a transit pass associated with the communication device 110 (e.g., the communication device 110 is identified with the transit system as having accessed the system in the past, or otherwise opened an account with the transit system, etc.), the patron or user may be allowed or declined access to the transit location 120 based on the transit pass (e.g., having sufficient funds, good standing, etc.) (step 616).

If a determination is made in step 614 that the communication device 110 is not associated with a transit pass, one or more relevant checks may be initiated by the access device 200 (step 618). For example, the system may determine whether the device or credential associated with the user is enabled for an offline data authentication (ODA) process (e.g., to check whether the device is counterfeit, etc.). In another example, the system may determine whether the credential is associated with a negative file (e.g., high risk devices, fraudulent devices, etc.). The checks may be completed within a time threshold and/or implemented one or more times throughout the process (step 620). If the relevant checks are not passed by the communication device 110, the patron or user may be denied access to the transit location 120 and the negative file may be updated accordingly, as described above (step 622).

If the relevant checks are passed by the communication device 110, the method may continue by transmitting the online authorization request message to the authorizing entity and simultaneously initiating the ODA process (steps 624 and 646), as described with respect to FIG. 5. The rest of the method may continue according to the description with respect to FIG. 5. In FIG. 6, reference numbers 610, 612, 624, 626, 630, 632, 634, 636, 638, 640, 642, 644, 646, 648, 650, 652, and 654 are respectively similar to reference numbers 510, 512, 514, 516, 518, 520, 522, 524, 526, 528, 530, 532, 534, 536, 538, 540 and 542 in FIG. 5, and the descriptions of those steps are incorporated herein.

The embodiments provided above provide many advantages. ODA is performed to combat counterfeit risk. This check is done locally at the access device to ensure that the account associated with the communication device is valid and is not counterfeit.

Online authorization may be used to reduce credit risk. A transit agency could send an account verification ($0 authorization) to confirm that the account is in good standing at the authorizing or issuing bank. This does not authorize for a specific amount, but does ensure that the account is in good standing—including protecting against lost and stolen fraud. An agency may use this if they do transaction aggregation (e.g., bundling multiple transactions—e.g., 3 days up to $15—to reduce cost of acceptance) or if it is a variable fare model (i.e., fares are dependent on the length of the ride) since the agency won't know the final fare amount until the user exits or taps out of the transit system. An agency will do an authorization for a specific amount once it is known. An agency could also send an online authorization for a specific amount. For example, an agency may be a fixed fare model (i.e., same fare regardless of distance) or they may be doing a fare estimate and then adjusting the amount once the ride(s) is complete before settlement. This would ensure the account is in good standing and that the individual has sufficient funds.

Accordingly, performing both the ODA and online authorization simultaneously can provide for increased fraud protection and lower risk (e.g., transaction security), while allowing for the rapid processing of patrons through a transit system.

A computer system with any suitable number of subsystems may be used to implement any of the entities or components described above. The subsystems can be interconnected via a system bus. Additional subsystems include a printer, keyboard, system memory, and monitor, which is coupled to a display adapter. Peripherals and input/output (I/O) devices may couple to an I/O controller. For example, an external interface can be used to connect the computer system to a wide area network such as the Internet, a mouse input device, or a scanner, via an input/output port. The interconnection via system bus allows the central processor to communicate with each subsystem and to control the execution of instructions from system memory or the storage device(s), as well as the exchange of information between subsystems. The system memory and/or the storage device(s) may be embodied by a non-transitory computer-readable medium.

While the examples above are provided in the context of transit systems, the embodiments described herein may be applied for entry to buildings, sporting events, concert venues, hotel rooms, or any other establishment where speed is important and it is beneficial to confirm that the individual with the device (e.g., card, phone, wearable) is the appropriate owner.

The software components or functions described in this application, may be implemented as software code to be executed by one or more processors using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may also reside on or within a single computational apparatus, and may be present on or within different computational apparatuses within a system or network.

Some embodiments of the present invention can be implemented in the form of control logic in software or hardware or a combination of both. The control logic may be stored in an information storage medium as a plurality of instructions adapted to direct an information processing device to perform a set of steps disclosed in an embodiment of the present invention. Based on the disclosure and teachings provided herein, a person of ordinary skill in the art will appreciate other ways and/or methods to implement the present invention.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

All patents, patent applications, publications, and descriptions mentioned above are herein incorporated by reference in their entirety for all purposes. None is admitted to be prior art.

What is claimed is:

1. A method, comprising:
receiving, by an access device and from a communication device operated by a user, credential data;
simultaneously transmitting, by the access device, the received credential data in an authorization request message to a server computer and initiating, by the access device, an offline data authentication (ODA) process using the received credential data; and
in response to receiving, by the access device and from the server computer, an authorization response message within a predetermined period of time after transmitting the credential data in the authorization request message to the server computer, determining whether to grant or deny the user access to a resource based on the received authorization response message, otherwise determining whether to grant or deny the user access to the resource based on a result of the ODA process.

2. The method of claim 1, wherein the predetermined period of time is 500 milliseconds (ms).

3. The method of claim 1, wherein the resource is at least one of a transit system, event venue, or building.

4. The method of claim 1, wherein the communication device comprises at least one of a mobile device or a payment card.

5. The method of claim 1, wherein the credential data comprises a primary account number associated with the communication device, and wherein the primary account number is used to initiate transactions at other access devices.

6. The method of claim 1, further comprising updating a blacklist based on at least one of the received authorization response message or the result of the ODA process.

7. The method of claim 1, further comprising, in response to receiving, by the access device and from the server computer, the authorization response message following the predetermined period of time after transmitting the credential data in the authorization request message to the server computer, updating a blacklist based on the received authorization response message.

8. The method of claim 1, wherein the credential data comprises a cryptogram, and wherein the result of the ODA process is indicative of whether the cryptogram is valid.

9. The method of claim 1, wherein the server computer is a part of a payment processing network.

10. The method of claim 1, wherein the credential data is received via a contactless communication protocol.

11. An access device, comprising:
a processor; and
a computer readable medium coupled to the processor, the computer readable medium comprising code, executable by the processor, for implementing a method comprising:
receiving from a communication device operated by a user, credential data;
simultaneously transmitting the received credential data in an authorization request message to a server computer and initiating, by the access device, an offline data authentication (ODA) process using the received credential data; and
in response to receiving, from the server computer, an authorization response message within a predetermined period of time after transmitting the credential data in the authorization request message to the server computer, determining whether to grant or deny the user access to a resource based on the received authorization response message, otherwise determining whether to grant or deny the user access to the resource based on a result of the ODA process.

12. The access device of claim 11, wherein the predetermined period of time is 500 milliseconds (ms).

13. The access device of claim 11, wherein the resource is at least one of a transit system, event venue, or building.

14. The access device of claim 11, wherein the communication device comprises at least one of a mobile device or a payment card.

15. The access device of claim 11, wherein the credential data comprises a primary account number associated with the communication device, and wherein the primary account number is used to initiate transactions at other access devices.

16. The access device of claim 11, wherein the method further comprises updating a blacklist based on at least one of the received authorization response message or the result of the ODA process.

17. The access device of claim 11, wherein the method further comprises, in response to receiving, by the access device and from the server computer, the authorization response message following the predetermined period of time after transmitting the credential data in the authorization request message to the server computer, updating a blacklist based on the received authorization response message.

18. The access device of claim 11, wherein the credential data comprises a cryptogram, and wherein the result of the ODA process is indicative of whether the cryptogram is valid.

19. The access device of claim 11, wherein the server computer is a part of a payment processing network.

20. The access device of claim 11, wherein the credential data is received via a contactless communication protocol.
